(19) United States
(12) Patent Application Publication
(10) Pub. No.: US 2008/0204206 A1
(43) Pub. Date: Aug. 28, 2008

(54) Transceiver-Transponder System

(75) Inventor: Manfred Frohler, Muhlhausen (DE)

Correspondence Address: BAKER BOTTS L.L.P.;PATENT DEPARTMENT, 98 SAN JACINTO BLVD., SUITE 1500, AUSTIN, TX, 78701-4039, US

(73) Assignee: SIEMENS AKTIENGESELLSCHAFT, Munchen (DE)

(21) Appl. No.: 11/573,665

(22) PCT Filed: Jul. 20, 2005
(86) PCT No.: PCT/EP05/53528

§ 371 Date: Feb. 13, 2007

(30) Foreign Application Priority Data
Aug. 13, 2004 (DE) 10 2004 039 401.6

(51) Int. Cl. B60R 25/10; G06K 19/07; G06K 7/00

(52) U.S. Cl. 340/426.1

(57) ABSTRACT

A transceiver/transponder system has a transceiver (1) with a transceiver oscillating circuit (2, 3), at least one transponder (10) with a transponder oscillating circuit (11, 12), and an energy accumulator (13). The transceiver (1) and the transceiver oscillating circuit (2, 3) are designed in such a manner that the transceiver oscillating circuit (2, 3) is caused to oscillate with a predetermined frequency for at least one charging duration (T_L). The transponder (10), the transponder oscillating circuit (11, 12) and the energy accumulator (13) are designed in such a manner that the energy accumulator (13) is charged while the transponder oscillating circuit (11, 12) is caused to oscillate by the transceiver oscillating circuit (2, 3). The transponder (10) additionally has a time measuring device (15), which is configured for determining a duration value that is characteristic of a charged state of the energy accumulator (13).

### CROSS-REFERENCE TO RELATED APPLICATIONS

This application is a U.S. national stage application of International Application No. PCT/EP2005/053528 filed Jul. 20, 2005, which designates the United States of America, and claims priority to German application number DE 10 2004 039 401.6 filed Aug. 13, 2004, the contents of which are hereby incorporated by reference in their entirety.

### TECHNICAL FIELD

The invention relates to a transceiver-transponder system which comprises a transceiver with a transceiver oscillating circuit and a transponder with a transponder oscillating circuit and an energy accumulator which are constructed such that the energy accumulator in the transponder is charged while the transponder oscillating circuit is caused to oscillate by the transceiver oscillating circuit.

### BACKGROUND

The transceiver oscillating circuit and the transponder oscillating circuit are inductively coupled to each other for transmitting energy signals and data signals. A duration which is required for charging the energy accumulator in the transponder is dependent on the spatial arrangement of the transceiver and the transponder to each other, on an excitation frequency with which the transceiver oscillating circuit and/or the transponder oscillating circuit is/are caused to oscillate, on a resonance frequency of the transceiver oscillating circuit and the transponder oscillating circuit and on a quality of the transceiver oscillating circuit and the transponder oscillating circuit.

Efficient transmission of the energy and data signals requires the transceiver oscillating circuit and the transponder oscillating circuit to have the same resonance frequency and to each be caused to oscillate with the excitation frequency which is equal to the resonance frequency. Owing to the component tolerances and temperature influences the situation may however occur where the resonance frequency of the transceiver oscillating circuit and the transponder oscillating circuit and the excitation frequency differ from each other.

DE 195 46 171 C1 discloses an anti-theft system for a motor vehicle comprising a transceiver arranged in the motor vehicle and a portable transponder. A transceiver oscillating circuit is caused to oscillate with a predetermined frequency by an oscillator, so energy signals are transmitted to the transponder at this frequency. A transponder energy accumulator is charged by the energy signal of the transceiver. The transponder subsequently transmits a data signal to the transceiver at the resonance frequency of the transponder oscillating circuit. The transceiver has a frequency counter to which the data signals are supplied and which detects the resonance frequency of the transponder oscillating circuit. A control unit in the transceiver, which is connected to the frequency counter and to the oscillator, controls the oscillator in such a way that the transceiver oscillating circuit is caused to oscillate at a frequency which substantially matches the measured resonance frequency of the transponder oscillating circuit.

EP 0 840 832 B1 discloses an anti-theft system for a motor vehicle which comprises a stationarily arranged unit with an antenna, which is part of a first oscillating circuit, and a portable unit with a coil, which is part of a second oscillating circuit, and an energy accumulator. The first oscillating circuit is caused to oscillate with an oscillator frequency by an oscillator. For a first, predetermined duration an excitation frequency is changed within a predetermined frequency range to inductively transmit energy signals from the antenna to the coil, so the energy accumulator of the portable unit is at least partially charged.

The transceiver does not have any information about the charged state of the energy accumulator in the transponder, so with good coupling between transceiver and transponder the energy accumulator is charged for longer than necessary.

### SUMMARY

The object of the invention is to provide a transceiver-transponder system in which a charged state of an energy accumulator may be easily determined.

The object can be achieved by a transceiver-transponder system which comprises a transceiver with a transceiver oscillating circuit which is constructed such that the transceiver oscillating circuit is caused to oscillate for at least one charging duration with a predetermined frequency, and at least one transponder with a transponder oscillating circuit and an energy accumulator which is constructed such that the energy accumulator is charged while the transponder oscillating circuit is caused to oscillate by the transceiver oscillating circuit, wherein the transponder comprises a time measuring device which is constructed for determining a duration value that is characteristic of a charged state of the energy accumulator.

### BRIEF DESCRIPTION OF THE DRAWINGS

Exemplary embodiments of the invention are described hereinafter with reference to the schematic drawings, in which:

FIG. 1 shows a transceiver-transponder system,

FIG. 2 shows a resonance curve of an oscillating circuit,

FIG. 3 shows a voltage-time graph,

FIG. 4 shows a flowchart.

Elements of identical construction or function are provided with the same reference numerals throughout the figures.

### DETAILED DESCRIPTION

According to an embodiment, a transceiver-transponder system may comprise a transceiver with a transceiver oscillating circuit and at least one transponder with a transponder oscillating circuit and an energy accumulator. The transceiver and the transceiver oscillating circuit are constructed such that the transceiver oscillating circuit is caused to oscillate for at least one charging duration with a predetermined frequency. The transponder, the transponder oscillating circuit and the energy accumulator are constructed such that the energy accumulator is charged while the transponder oscillating circuit is caused to oscillate by the transceiver oscillating circuit.

According to an embodiment, the transponder may comprise a time measuring device which is constructed for determining a duration value that is characteristic of a charged state of the energy accumulator. It may be determined from the known charging duration and the duration value at what instant within the charging duration a predetermined charged state of the energy accumulator is attained. If this predetermined charged state of the energy store is attained at an early instant within the charging duration, coupling between transceiver and transponder is good and a lot of energy can be transmitted from the transceiver to the transponder in a short period of time. If the predetermined charged state of the energy accumulator is attained at a late instant within the charging duration, however, coupling between transceiver and transponder is poor and only a small amount of energy can be transmitted from the transceiver to the transponder in the short period of time.

According to an embodiment, the time measuring device can be constructed as a simple counter which is clocked with a predetermined counting frequency. If the transponder comprises a microcontroller, according to an embodiment, then this can assume the function of the counter. In this case an additional circuit for the counter may be dispensed with in the transponder. The time measuring device is consequently very simple and inexpensive. Additional energy consumption is also avoided by dispensing with additional components.

According to an embodiment, the transponder can be constructed for transmitting the duration value to the transceiver, and the transceiver is constructed to evaluate the transmitted duration value. The charged state of the energy accumulator in the transponder is thus known to the transceiver. The information about the charged state of the energy accumulator in the transponder can for example be used to improve the coupling between the transceiver and the transponder, to evaluate a spacing between the transceiver and the transponder or to evaluate the spatial orientation of the transceiver and the transponder to each other.

According to an embodiment, the information about the charged state of the energy accumulator in the transponder may also be used to evaluate positioning of an antenna of the transceiver or transponder. If, for example, the antenna is positioned very close to metal, for instance at a spacing of 1 to 2 cm, the characteristic of the field lines may be so strongly influenced as a result that the coupling between the transceiver and the transponder deteriorates. This effect is also called the “close-to-metal effect”.

It is also possible, according to an embodiment, to evaluate an adjustment of an oscillating frequency of the transceiver oscillating circuit to the resonance frequency of the transponder oscillating circuit. This may be used in particular to compensate changes in the resonance frequency of the transponder oscillating circuit, which are caused for example by temperature changes, by a corresponding correction of the oscillating frequency of the transceiver oscillating circuit. Reliable charging of the transponder energy accumulator is thus possible even with changing ambient conditions.

According to an embodiment, it may be advantageous if the transceiver is constructed for changing at least one charging parameter as a function of the transmitted duration value. Consequently the function of the transceiver-transponder system may also be ensured with changing ambient conditions since the transponder energy accumulator is reliably charged. The situation may also be prevented where more energy is transmitted from the transceiver to the transponder than is necessary for operation of the transponder. Energy is thus transmitted more efficiently and in a more energy-saving manner.

According to an embodiment, it may be advantageous if a charging parameter is the predetermined duration. This has the advantage that the energy accumulator in the transponder can be charged for as short a time as possible. However, this can simultaneously ensure that the transponder is changed for as long as the amount of energy required for operation of the transponder is available in the transponder. If coupling between the transceiver and the transceiver is good, the charging duration can be short. This allows a higher interrogating frequency of the transponder by the transceiver. The transceiver also conserves energy if the charging duration is short. The charging duration is a charging parameter which can be changed very easily.

Alternatively or additionally, according to an embodiment, it may be advantageous if a charging parameter is the predetermined frequency. By adjusting the oscillating frequency of the transceiver oscillating circuit to the resonance frequency of the transponder oscillating circuit coupling between the transceiver and the transponder is improved, so the charging duration may for example be reduced. The interrogating frequency of the transponder by the transceiver may also be increased as a result. It is also possible to compensate temperature-dependent changes in the resonance frequency of the transceiver oscillating circuit and the transponder oscillating circuit and to adjust the resonance frequencies to each other.

According to an embodiment, the transponder can be constructed for detecting a temperature and for transmitting the temperature to the transceiver. The transceiver is constructed for evaluating the transmitted temperature and for changing at least one charging parameter as a function of the transmitted duration value and the transmitted temperature. The transmitted temperature can be used to purposefully compensate temperature-dependent changes in the resonance frequency of the transponder oscillating circuit, in other words by taking account of the determined temperature.

According to an embodiment, the transceiver can be constructed for reducing the predetermined frequency if the transmitted temperature is higher than a temperature transmitted at an earlier instant, and for increasing the predetermined frequency if the transmitted temperature is lower than a temperature transmitted at an earlier instant. Targeted adjustment of the predetermined frequency to the resonance frequency of the transponder oscillating circuit, as a function of the direction of the change in temperature, is possible as a result. The advantage is that different frequencies do not have to be tested one after the other to be able to establish the direction of the change in the resonance frequency.

According to an embodiment, the transponder can be constructed for starting the time measuring device as a function of the charged stated of the energy accumulator. A resetting signal for example may thus be easily triggered if the charged state of the energy accumulator exceeds a predetermined minimum value or threshold. This resetting signal can be used to bring a transponder control unit into a predetermined initial state and to start the time measuring device.

According to an embodiment, it may be advantageous that the transponder is constructed for stopping the time measuring device if charging of the energy accumulator is stopped by the transceiver. This has the advantage that the end of transmission of the energy signal can be detected very easily by the transponder. Alternatively, according to an embodiment, the transponder can be constructed for stopping the time measuring device once the transceiver has transmitted a message to the transponder. The transceiver may consequently stipulate, irrespective of transmission of the energy signals, at which instant the transponder stops the time measuring device.

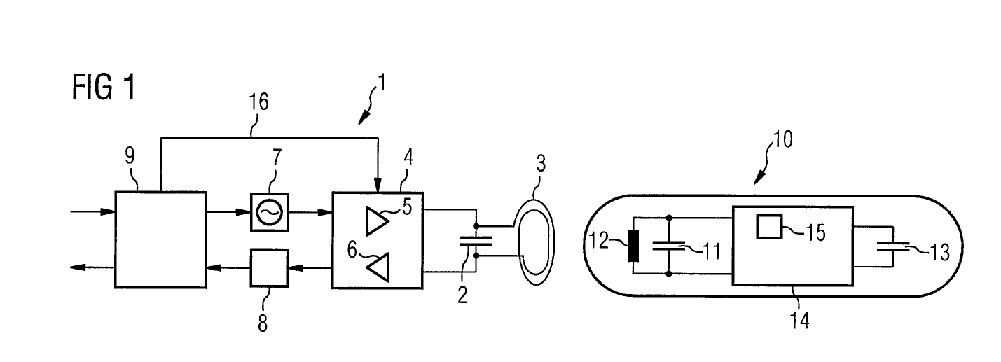

FIG. 1 shows a transceiver-transponder system comprising a transceiver 1 with a first capacitor 2 and an antenna 3, which form a transceiver oscillating circuit 2, 3, with an amplifier unit 4, which comprises a power amplifier 5 and a receiving amplifier 6, with an oscillator 7, a demodulator 8 and a transceiver control unit 9. The transceiver control unit 9 controls the oscillator 7 such that the transceiver oscillating circuit 2, 3 is caused to oscillate with an excitation frequency f_E. This oscillation is amplified by the power amplifier 5 such that a transponder 10 with a second capacitor 11 and a coil 12, which form a transponder oscillating circuit 11, 12, can be supplied with energy.

The energy is transmitted from the transceiver 1 to the transponder 10 for example by inductive coupling of the transceiver oscillating circuit 2, 3 and the transponder oscillating circuit 11, 12. The transponder 10 also comprises an energy accumulator 13 which is charged by the electrical energy supplied to it which is coupled into the transponder oscillating circuit 11, 12. The energy accumulator 13 is for example a capacitor or a different accumulator.

The transponder 10 also comprises a transponder control unit 14 with a time measuring device 15. The transponder control unit 14 is for example a finite state machine or a microcontroller and is preferably constructed as an integrated circuit. The transponder control unit 14 is supplied with energy by the energy accumulator 13.

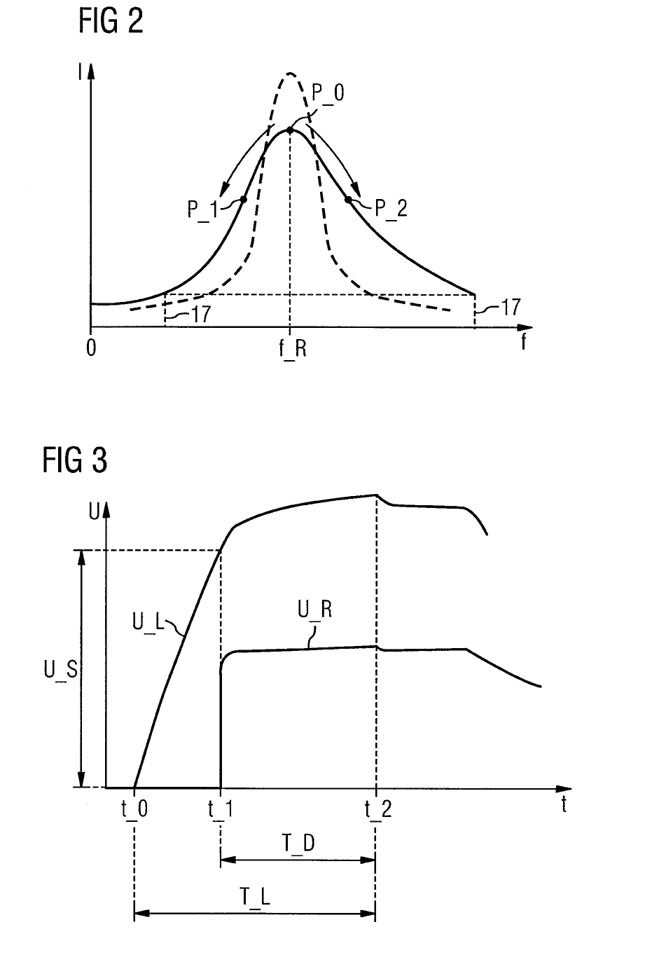

FIG. 2 shows a resonance curve (resonance curve shown by solid line) in which the intensity of oscillation of the transceiver oscillating circuit or the transponder oscillating circuit, i.e. the field strength or amplitude, is plotted against the frequency f. An operating point P_i of an oscillating circuit is dependent on the excitation frequency f_E. The greatest intensity I is achieved if at an operating point P_0 the excitation frequency f_E is equal to a resonance frequency f_R. At the operating point P_0 a lot of energy can be transmitted in a short time and the energy accumulator in the transponder can be rapidly charged accordingly.

If, however, the excitation frequency f_E differs from the resonance frequency f_R, the intensity I reduces and energy transmission is less efficient. This is illustrated by the operating points P_1 and P_2. If the excitation frequency f_E differs from the resonance frequency F_R to the extent that the intensity lies below a power limit 17, it is no longer possible to transmit sufficient energy from the transceiver 1 to the transponder 10 to reliably charge the energy accumulator 13 in the transponder 10.

If the quality of the transceiver oscillating circuit 2, 3 or the transponder oscillating circuit 11, 12, is high (resonance curve shown in broken lines), a greater intensity I may be attained at the operating point P_0 and more energy can be transmitted in a short time. However the intensity I reduces in operating points P_1 and P_2 more sharply than in the resonance curve of the oscillating circuit which is of poorer quality (resonance curve shown by solid line). The high quality of the oscillating circuit allows better coupling between the transceiver 1 and the transponder 10 and transmission of the energy over a greater distance. The operating point P_0 still has to be well adjusted however.

FIG. 3 shows a voltage-time graph with a characteristic over time of a charging voltage U_L and a resetting voltage U_R. The charging voltage U_L is characteristic of the charged state of the energy accumulator 13. The resetting voltage U_R can be used for example to bring the transponder control unit 14 into a predetermined initial state and/or to start the time measuring device 15.

At an instant t_0 the transponder oscillating circuit 11, 12 is caused to oscillate by the transceiver oscillating circuit 2, 3 and energy is transmitted from the transceiver 1 to the transponder 10. The transmitted energy is stored in the energy accumulator 13, so the charging voltage U_L increases. The greater the charging voltage U_L is, the more energy is stored in the energy accumulator 13. The charging voltage U_L increases non-linearly toward a saturation limit, not shown.

At an instant t_1 the charging voltage U_L is greater than or equal to a threshold voltage U_S. At the instant t_1 the resetting voltage U_R therefore increases almost erratically. This can be achieved for example by a simple threshold switch which closes or opens an electrical circuit as a function of a potential difference that corresponds to the threshold voltage U_S. The threshold voltage U_S, which is for example about 2 or 3 V, can be a minimum voltage which requires an electronic circuit or a microcontroller in the transponder control unit 14 to be able to execute predetermined program steps.

At an instant t_2 the transceiver 1 ends the transmission of energy signals for charging the energy accumulator 13. After the instant t_2 the transponder 10 transmits a data signal to the transceiver 1.

A charging duration T_L is defined as the duration between the instant t_0 and the instant t_2, in other words the duration during which the energy signal is generated by the transceiver 1 and transmitted to the transponder 10. A duration value T_D is defined as the duration between the instant t_1 and the instant t_2, in other words between the instant at which the charging voltage U_L is greater than or equal to the threshold voltage U_S, and the end of transmission of the energy signals by the transceiver 1.

From the charging duration T_L and the duration value T_D the instant t_1 which is equal to a total of the instant t_0 and the charging duration T_L minus the duration value T_D may very easily be determined. If the duration between instant t_0 and instant t_1 is short, the characteristic of the charging voltage U_L is steep and the energy accumulator 13 will be rapidly charged. If the duration between instant t_0 and instant t_1 is long however, the curve of the charging voltage U_L is flat and the energy accumulator 13 is charged only slowly. If the duration value T_D is high, the energy accumulator 13 is efficiently charged. If, however, the duration value T_D is short, only a little more energy is stored in the energy accumulator 13 than is at least required for starting the electronic circuit or the microcontroller. The duration value T_D is therefore characteristic of the charged state of the energy accumulator 13 in the transponder 10.

After instant t_1 the curve of the charging voltage U_L can bend and assume a flatter course. This can be caused by starting of the electronic circuit or the microcontroller and the discharging associated therewith of the energy accumulator 13.

The time measuring device 15 is constructed for determining the duration value T_D that is characteristic of the charged state of the energy accumulator 13. The determined duration value T_D can be used, for example, to evaluate and improve the coupling between the transceiver oscillating circuit 2, 3 and the transponder oscillating circuit 11, 12. For example the transponder control unit 14 can transmit the duration value T_D to the transceiver 1 by means of the transponder oscillating circuit 11, 12. The data signal of the transponder 10 is amplified in the receiving amplifier 6, demodulated by the demodulator 8 and supplied to the transceiver control unit 9.

The transceiver control unit 9 is constructed for evaluating the transmitted duration value T_D. The transceiver control unit 9 can for example activate the oscillator 7 or the amplifier unit 4 via a control line 16 in such a way that the transceiver oscillating circuit 2, 3 oscillates with a frequency close to the resonance frequency of the transponder oscillating circuit 11, 12. The coupling between the transceiver and the transponder can be improved such that only the amount of energy required by the transponder 10 is transmitted to the transponder. For this purpose, for example the power amplifier 5 in the amplifier unit 4 is activated only for the charging duration T_L. The charging duration T_L is preferably selected such that the determined duration value T_D lies within a predetermined duration range. The control line 16 may also be used to switch over between amplification of the energy signal by the power amplifier 5 and amplification of the data signal from the transponder 10 by the receiving amplifier 6.

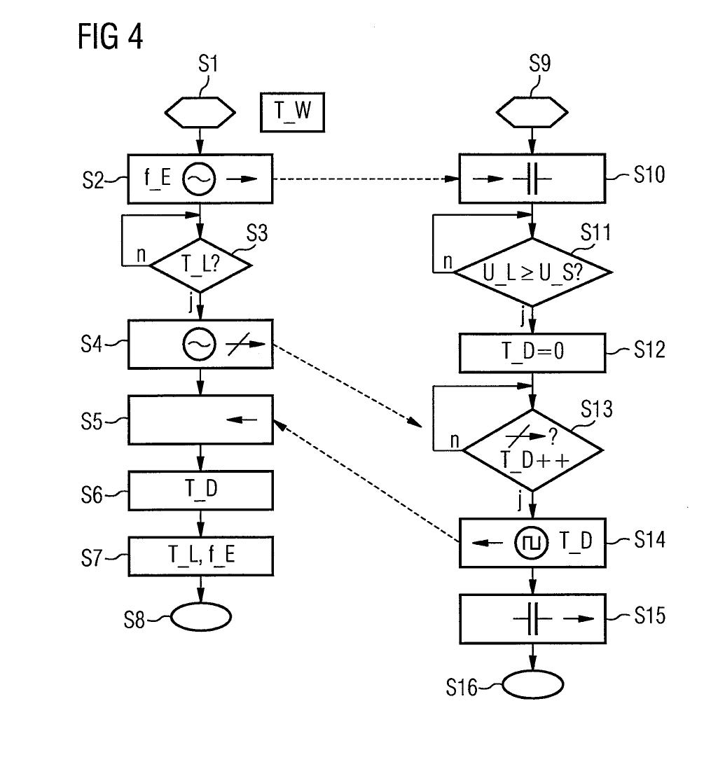

FIG. 4 shows a flowchart with program steps which are executed in the transceiver 1 and the transponder 10 to adjust the charging parameters in the transceiver 1 to the current coupling of the transceiver 1 and transponder 10. The transceiver 1 starts in a step S1 in which for example the current charging parameters, the excitation frequency f_E and the charging duration T_L, are retrieved from a memory. In step S2 an energy signal is generated by the oscillator 7 generating an oscillation with the excitation frequency f_E which is amplified by the power amplifier 5. The energy signal has, for example, a power of a few tens of watts, for example 30 watts.

In a step S3 it is checked whether the charging duration T_L has expired. Once the energy signal for the charging duration T_L has been generated, generation of the energy signal is ended in step S4. The receiving amplifier 6 is subsequently activated in step S5 to amplify a data signal from the transponder 10 and to demodulate it in the demodulator 8. In step S6 the demodulated data signal is evaluated in the transceiver control unit 9. The duration value T_D transmitted by the transponder 10 is evaluated in particular and in step S7 the charging parameters, in other words the charging duration T_L and the excitation frequency f_E for example, are optionally adjusted. The program sequence of the transceiver 1 end in a step S8 and can be executed afresh in step S1 following a waiting period T_W. In step S1 the adjusted charging parameters are used to generate the energy signal.

The flowchart of the transponder 10 begins in step S9. In step S10 the energy accumulator 13 is charged by the energy which is coupled from the transceiver 1 into the transponder oscillating circuit 11, 12. It is checked in step S11 whether the charging voltage U_L is greater than or equal to the threshold voltage U_S. If this condition is fulfilled, a counter, which determines a duration value T_D, is initialized and started in step S12. It is checked in step S13 whether transmission of the energy signal from the transceiver 1 has been terminated. The counter for determining the duration value T_D is increased at predetermined intervals. If the condition is fulfilled in step S13, the transponder transmits the determined duration value T_D, and optionally further data, to the transceiver 1 by means of a data signal in step S14. In step S15 the energy accumulator 13 is discharged, so the charging voltage U_L assumes a predetermined minimum value, so with renewed charging of the transponder in step S10 defined initial conditions are given for determining the duration value T_D. Once the discharging process has ended in step S15 the flowchart is ended in step S16.

The transceiver 1 can also be constructed for transmitting a data signal to the transponder 10, for example in the form of a message or a code word. Transmission of the data signal from the transceiver to the transponder 10 can be achieved very easily in that via the control line 16 the transceiver control unit 9 switches the power amplifier 5 in the amplifier unit 4 on and off in sequence such that the amplitude of the oscillation of the transceiver oscillating circuit 2, 3 is modulated according to the coded message or code word. A message or code word transmitted in this way can also be used for example to control the time measuring device 15 in the transponder control unit 14, for example to stop it.

The time measuring device 15 for example can also be stopped if the charging voltage U_L is greater than or equal to a further predetermined threshold voltage which is greater than the threshold voltage U_S. The duration value T_D can be determined in this case as a function of the duration between a threshold voltage U_S being reached and the further predetermined threshold being reached.

It is also possible for the transponder 10 to use the determined duration value T_D to for example adjust the resonance frequency of the transponder oscillation circuit 11, 12 to the excitation frequency f_E of the transceiver 1.

The transceiver-transponder system can for example be used to monitor tire pressure in the wheels of a motor vehicle. The transponder 10 is arranged in a rim or in a tire of a wheel and comprises a pressure sensor for detecting the air pressure in the tire and preferably a temperature sensor for detecting the temperature in the tire. Since the resonance frequency of the transponder oscillating circuit 11, 12 is dependent on the temperature, the temperature determined with the temperature sensor can for example be used to adjust the excitation frequency f_E and the resonance frequency f_R of the transponder oscillating circuit 11, 12 to each other. The determined pressure, the determined temperature and the determined duration value T_D are preferably transmitted to the transceiver 1.

What is claimed is:

1. A transceiver-transponder system which comprises:
a transceiver with a transceiver oscillating circuit which is constructed such that the transceiver oscillating circuit is caused to oscillate for at least one charging duration with a predetermined frequency, and
at least one transponder with a transponder oscillating circuit and an energy accumulator which is constructed such that the energy accumulator is charged while the transponder oscillating circuit is caused to oscillate by the transceiver oscillating circuit,
the transponder comprises a time measuring device which is constructed for determining a duration value that is characteristic of a charged state of the energy accumulator.

2. The transceiver-transponder system according to claim 1, wherein
the transponder is constructed for transmitting the duration value to the transceivers, and in that the transceiver is constructed to evaluate the transmitted duration value.

3. The transceiver-transponder system according to claim 2, wherein the transceiver is constructed for changing at least one charging parameter as a function of the transmitted duration value.

4. The transceiver-transponder system according to claim 3, wherein
a charging parameter is the charging duration.

5. The transceiver-transponder system according to claim 3, wherein
a charging parameter is the predetermined frequency.

6. The transceiver-transponder system according to claim 2, wherein
the transponder is constructed for detecting a temperature and for transmitting the temperature to the transceiver and the transceiver is constructed for evaluating the transmitted temperature and for changing at least one charging parameter as a function of the transmitted duration value and the transmitted temperature.

7. The transceiver-transponder system according to claim 6, wherein
the transceiver is constructed for reducing the predetermined frequency if the transmitted temperature is higher than a temperature transmitted at an earlier instant, and for increasing the predetermined frequency if the transmitted temperature is lower than a temperature transmitted at an earlier instant.

8. The transceiver-transponder system according to claim 1, wherein
the transponder is constructed for starting the time measuring device as a function of the charged state of the energy accumulator.

9. The transceiver-transponder system according to claim 8, wherein
the transponder is constructed for stopping the time measuring device if charging of the energy accumulator is ended by the transceiver.

10. The transceiver-transponder system according to claim 8, wherein
the transponder is constructed for stopping the time measuring device once the transceiver has transmitted a message to the transponder.

11. A transceiver-transponder system which comprises:
a transceiver with a transceiver oscillating circuit oscillating for at least one charging duration with a predetermined frequency, and
at least one transponder with a transponder oscillating circuit, an energy accumulator being charged while the transponder oscillating circuit is oscillating, and a time measuring device determining a duration value that is characteristic of a charged state of the energy accumulator.

12. The transceiver-transponder system according to claim 11, wherein
the transponder is constructed for transmitting the duration value to the transceiver, and in that the transceiver is constructed to evaluate the transmitted duration value.

13. The transceiver-transponder system according to claim 12, wherein
the transceiver is constructed for changing at least one charging parameter as a function of the transmitted duration value.

14. The transceiver-transponder system according to claim 13, wherein
a charging parameter is the charging duration.

15. The transceiver-transponder system according to claim 13, wherein
a charging parameter is the predetermined frequency.

16. The transceiver-transponder system according to claim 12, wherein
the transponder is constructed for detecting a temperature and for transmitting the temperature to the transceiver and the transceiver is constructed for evaluating the transmitted temperature and for changing at least one charging parameter as a function of the transmitted duration value and the transmitted temperature.

17. The transceiver-transponder system according to claim 16, wherein
the transceiver is constructed for reducing the predetermined frequency if the transmitted temperature is higher than a temperature transmitted at an earlier instant, and for increasing the predetermined frequency if the transmitted temperature is lower than a temperature transmitted at an earlier instant.

18. The transceiver-transponder system according to claim 11, wherein
the transponder is constructed for starting the time measuring device as a function of the charged state of the energy accumulator.

19. The transceiver-transponder system according to claim 18, wherein
the transponder is constructed for stopping the time measuring device if charging of the energy accumulator is ended by the transceiver.

20. The transceiver-transponder system according to claim 18, wherein
the transponder is constructed for stopping the time measuring device once the transceiver has transmitted a message to the transponder.
